(19) United States
(12) Patent Application Publication
(10) Pub. No.: US 2017/0129355 A1
(43) Pub. Date: May 11, 2017

(54) ELECTRIC VEHICLE CHARGING SYSTEM

(71) Applicant: PAUL W. FOURNIER, Mascouche (CA)

(72) Inventors: Paul W. FOURNIER, Mascouche (CA); Daniel PLANTE, Montreal (CA)

(21) Appl. No.: 15/316,951

(22) PCT Filed: Jul. 14, 2015
(86) PCT No.: PCT/CA2015/050656

§ 371 Date: Dec. 7, 2016

Related U.S. Application Data
(60) Provisional application No. 62/024,604, filed on Jul. 15, 2014.

(51) Int. Cl. B60L 11/18

(52) U.S. Cl. CPC B60L 11/1825; B60L 11/1818

(57) ABSTRACT

A cable management system for an electric vehicle (EV) charging station comprises an upstanding enclosure having a cable opening though which an EV charging cable can be pulled for extension. The EV charging cable is provided at a free end thereof with an EV charging connector for connection with an EV charging socket of an EV. The EV charging cable is provided at an opposed fixed end thereof with an electric connector for connection with a mating connector mounted inside the enclosure. A fixed pulley is mounted within the upstanding enclosure for rotation about a first axis normal to an upstanding axis of the enclosure. The system further comprises a mobile pulley rotatable about a second axis parallel to the first axis. The mobile pulley is vertically translatable within a guiding structure mounted inside the upstanding enclosure for movement towards and away from the fixed pulley. The fixed pulley is mounted at a higher elevation than the mobile pulley. The EV charging cable extends over the fixed pulley and the mobile pulley between its opposed free and fixed ends. The mobile pulley is moveable against gravity from a lowered position to a raised position by the application of a sufficient pulling force at the free distal end of the EV charging cable. The mobile pulley returns at least partly under gravity to its lowered position upon release of the EV charging cable, thereby automatically retracting the cable inside the upstanding enclosure.

### TECHNICAL FIELD

The application relates generally to electric vehicles (EVs) and, more particularly, to a system for charging EVs.

### BACKGROUND OF THE ART

As EVs become more popular, municipalities are faced with the need to deploy charging station in the public domain, namely along some of their streets to accommodate EV users whom are in frequent need for charging, namely near their home. Although it is possible to recharge EVs with wireless systems, the common art is to use chargers with direct cable connection to vehicles. We have therefore started to see chargers being installed on sidewalks along the pavement in order to be near the vehicles requiring charging. In one type of configuration, two chargers are grouped together and placed between two EV parking places in order to connect both from that location. This results into a considerably big unit fitted with long cables to reach the EV charging socket which can be located anywhere around the EV. The chargers require an electrical entrance, breakers and power meters to be in compliance with the applicable electrical code. The result is normally a bulky installation surrounded by several twisted wires, at the same time using critical space on the sidewalk and being very vulnerable to impacts from vehicles on the street and snow removal equipment on the sidewalk.

Also the management of the EV charging cables (i.e. the power cables) is challenging. After usage, if the cables are kept loose or are not appropriately stored, the cables can become twisted along their lengths or a portion thereof may lie on the pavement where they can be easily damaged. In Nordic countries, the cables may even become stuck in ice, thereby impeding proper access thereto. Also, if not appropriately protected against thieves, the exposed length of cable can be easily stolen, when not in operation.

### SUMMARY

In one aspect, there is provided a cable management system for an electric vehicle (EV) charging station, the system comprising: an upstanding enclosure having a cable opening though which an EV charging cable can be pulled for extension, the EV charging cable being provided at a free end thereof with an EV charging connector for connection with an EV charging socket of an EV, the EV charging cable being provided at an opposed fixed end thereof with an electric connector for connection with a mating connector mounted inside the enclosure, a fixed pulley mounted within the upstanding enclosure for rotation about a first axis normal to an upstanding axis of the enclosure, and a mobile pulley rotatable about a second axis parallel to the first axis and vertically translatable within a guiding structure mounted inside the upstanding enclosure for movement towards and away from the fixed pulley, the fixed pulley being mounted at a higher elevation than the mobile pulley, wherein the EV charging cable extends over the fixed pulley and the mobile pulley between its opposed free and fixed ends, wherein the mobile pulley is moveable against gravity from a lowered position to a raised position by the application of a sufficient pulling force at the free distal end of the EV charging cable, and wherein the mobile pulley returns at least partly under gravity to its lowered position upon release of the EV charging cable, thereby automatically retracting the cable inside the upstanding enclosure.

In another aspect, there is provided an electric vehicle (EV) charging station comprising an upstanding enclosure, an EV charging cable having an EV charging connector at a free end thereof for connection with an EV charging socket of an EV and an electric connector at an opposed fixed end of the EV charging cable connected to a mating electric connector provided within the upstanding enclosure, the EV charging cable being displaceable between a retracted position in which a major portion of a length of the EV charging cable is stored within the enclosure and an extended position in which a sufficient length of cable is withdrawn from the enclosure for allowing a user to connect the EV charging connector to the EV charging socket of his/her EV, the EV charging cable between its opposed free and fixed ends being looped around a fixed pulley mounted within an upper end portion of the upstanding enclosure and one mobile pulley reciprocable along an upstanding axis inside the enclosure, wherein upon a sufficient tensile force acting on the free end of the EV charging cable, the mobile pulley is translated upwardly against gravity towards the fixed pulley, thereby extending the length of the EV charging cable available on a cable free end side of the fixed pulley.

### DESCRIPTION OF THE DRAWINGS

Reference is now made to the accompanying figures in which:

FIG. 1 is a perspective view of a master charger system for electric vehicles;

FIG. 2 is a diagram of the components of the master charger system shown in FIG. 1;

FIGS. 3a and 3b are schematic views illustrating the operation of a cable management system suited for use with the system shown in FIG. 1;

FIG. 4a is a perspective view of an embodiment of a pair of cable management systems;

FIG. 4b is an enlarged view illustrating a remotely operable electronic lock for selectively locking an EV charging cable in its retracted position inside a cable enclosure;

FIG. 4c is an enlarged view illustrating electromagnetic lock that can be used to lock the EV charging cable in its retracted position according to another embodiment; and

FIGS. 4d and 4e are enlarged views respectively illustrating side and top mounted counterweights on the mobile pulley of the cable management system.

### DETAILED DESCRIPTION

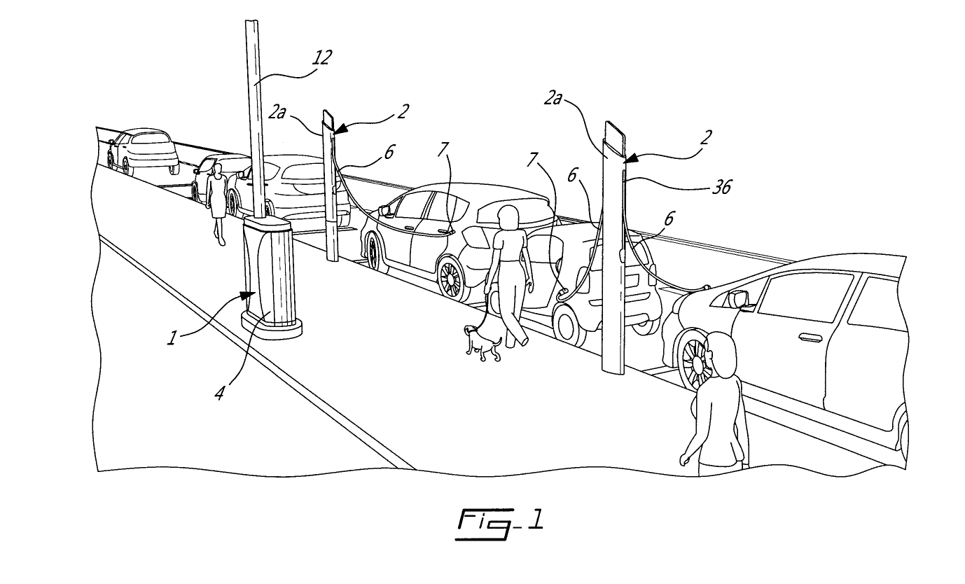

FIG. 1 illustrates one possible example of a centralized version of a EV charging system. In one aspect, this embodiment aims at removing bulky cabinets from the side of the pavement and locate it on the house side of the sidewalk, where it can be more easily installed out of the way and made less vulnerable to the various impacts. The system generally comprises a master charger unit 1 adapted to be operatively coupled to a given number of charging stations 2 (two in the illustrated embodiment). Each charging station 2 comprises an elongated upstanding enclosure 2a housing at least one power cable or EV charging cable 6 (two in the illustrated example) provided at a free end thereof with a EV charging connector 7 for connection with an EV charging socket of an EV.

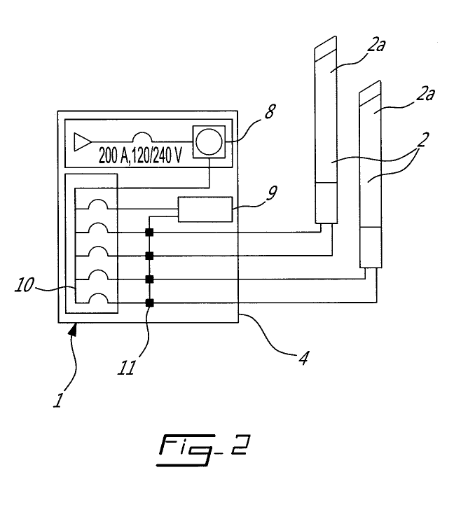

As shown in FIG. 2, the master charger unit 1 comprises a properly sized cabinet 4 housing a complete electrical entrance 8 with power and P.U. meter and a breaker panel 10, along with a charger unit and control relays 11. The master charger unit 1 may also comprise a user interface 9. As can be appreciated from FIG. 2, the master charger unit 1 may be operatively connected to a plurality of remotely disposed charging stations 2. The charging stations 2 may be positioned so that the charging cables 6 are accessible on the street side where they can be connected to the vehicles while being properly housed inside adequate yet less cumbersome enclosures.

The remote master charger unit 1 can be used for charging several vehicles all at once, instead of using one nearby charger per vehicle, which is normally the case in the prior art. The remote master charger system could also be for only two places and used in combination with energized bollards (not shown) disposed along the street and equipped with smart plugs. In all cases, the charging system can be fitted with recognition devices (RFD or other) at the connection point to allow the fast connection of registered users. In the case the user is not registered, the user is required to go to the master charger unit 1 to use the user interface 9 in order to register and then be authorized to use one of the available charging stations 2.

The master charger unit 1 can be built around a lamppost 12 or be free standing in another possible configuration. It can be housed inside a cabinet of various shape, namely cylindrical or oblong 1, and of various dimensions, depending on the required equipment and number of EVs it can charge simultaneously.

This approach may in some instances be more appropriate for the deployment of a charging infrastructure along the city streets, for EV owners with no driveway as well as for occasional users in a typical car sharing application. This system also has the potential to be more economical to install and to maintain, since only one unit is used for several charging places, and is, thus, less vulnerable to damage.

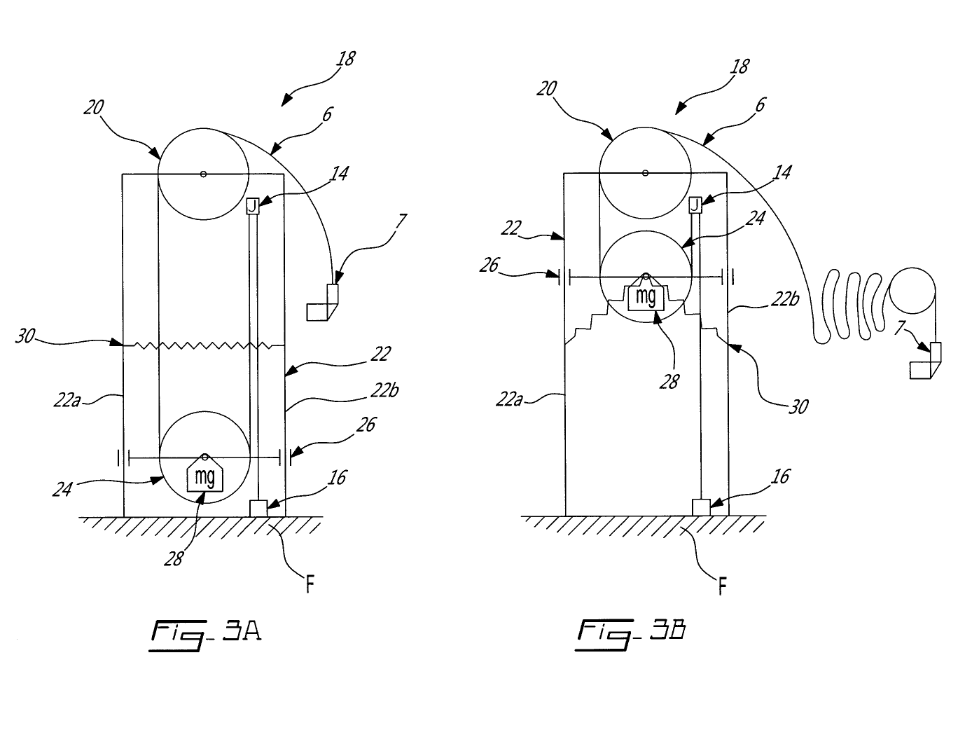

Each EV charging cable 6 may be retracted or extended from an associated opening provided at an upper end portion of the cable enclosure 2a. As shown in FIGS. 3a and 3b, each cable 6 is operatively connected at a fixed end thereof opposite to the EV charging connector 7 with an electrical junction box 14 mounted inside the upper end portion of the enclosure 2a. The junction box 14 is in turn operatively connected with the master charger 1 via an underground power line 16. Each cable 6 may be detachably connected to the electrical junction box 14 so that in the event of a predetermined excessive tensile or pulling force on the cable 6, as for instance in the event of an electric vehicle accidentally leaving the charging station 2 with the EV charging cable 6 still connected to the charging socket of the vehicle, the cable 6 is automatically released from the junction box 14.

As schematically exemplified in FIGS. 3a and 3b, each enclosure 2a may further house a cable management system 18 to automatically retract the EV charging cable 6 within its enclosure 2a upon disconnecting the EV charging connector 7 from the vehicle and releasing the cable 6. As will be seen hereinafter, the cable management system 18 also acts on the cable 6 such that the cable 6 is in tension (slack free) during retraction and withdrawal, thereby preventing the cable 6 from becoming twisted upon itself and to extend on the pavement.

Each cable management system 18 comprises a fixed pulley 20 mounted at an upper end of a support structure 22 erected within the enclosure 2a. The fixed pulley 20 is mounted for rotation about an axis normal to the upstanding axis of the enclosure 2a. In the illustrated embodiment, the upstanding axis is a vertical axis and the fixed pulley 20 is mounted for rotation about a horizontal axis. The support structure 22 may take the form of an upstanding rectangular frame anchored to the ground or any appropriate foundation, such as a concrete foundation F. A mobile pulley 24 having a rotation axis parallel to the rotation axis of the fixed pulley 20 is mounted within the rectangular frame underneath the fixed pulley 20 for up and down movement between a lowered position (FIG. 3a) and a raised position (FIG. 3b). The upright members 22a, 22b of the rectangular frames may be provided in the form of vertical tracks for engagement with runners 26 extending laterally from opposed sides of the mobile pulley 24. In this way, the rectangular frame of the support structure 22 may also be used as a guiding structure for guiding the mobile pulley 24 as the same is vertically moved towards and away from the fixed pulley 20. It is understood that other types of guiding structure could be used as well.

As shown in FIGS. 3a and 3b, the EV charging cable 6 runs over the fixed pulley 20, then downwardly, over the mobile pulley 24 and finally upwardly to its fixed point of connection to the junction box 14, which in the illustrated embodiment is disposed at an elevation generally corresponding to that of the fixed pulley 20. Accordingly, upon disconnecting the EV charging connector 7 from the EV charging socket of the vehicle and releasing the cable 6, the EV charging cable 6 automatically retracts into the enclosure 2a under the gravitational forces acting on the cable 6 and the mobile pulley 24. Indeed, upon releasing the cable 6, the mobile pulley 24 moves by gravity from its raised position (FIG. 3b) to its lowered position (FIG. 3a), thereby causing a length of cable generally corresponding to the stroke of the mobile pulley 24 to be pulled in the enclosure 2a. The cable 6 is linearly and freely accommodated in the enclosure 2a while remaining slack free by virtue of the gravitational forces acting on the cable 6 and the mobile pulley 24. In this way, the retractable cable 6 does not have to be wound on any support structure or reel. The cable is advantageously vertically stored in a minimal volume without running the risk of becoming twisted. The cable enclosure 2a can thus have an vertically elongated or slender profile. In other words, the footprint of the cable enclosure 2a can be minimized.

As shown in FIGS. 3a and 3b, a counterweight 28 may be mounted to the mobile pulley 24 to calibrate the tension in the cable 6 and, thus, adjust the cable retraction force. Also a partial stroke tensioner 30 may be provided to assist the initial phase of the return stroke of the mobile pulley 24 from its raised position to its lowered position. The partial stroke tensioner 30 may be positioned to act on the mobile pulley 24 only while the mobile pulley 24 is above a predetermined intermediate elevation. For instance, the partial stroke tensioner 30 may be provided in the form of a spring member mounted across the rectangular frame at a predetermined elevation between the upper and lower limit positions of the mobile pulley 24. In this way, the mobile pulley 24 may be spring loaded or otherwise biased towards its lowered position when in its raised position while being free from such a biasing force after a predetermined initial phase of the pulley's return stroke has been completed.

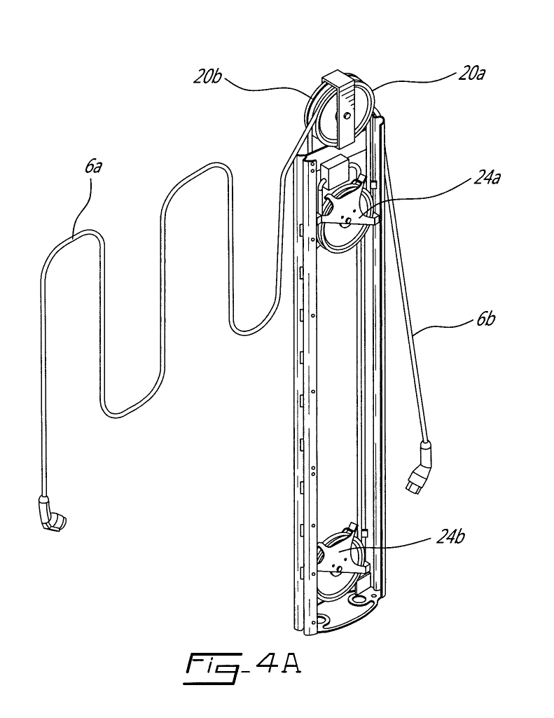

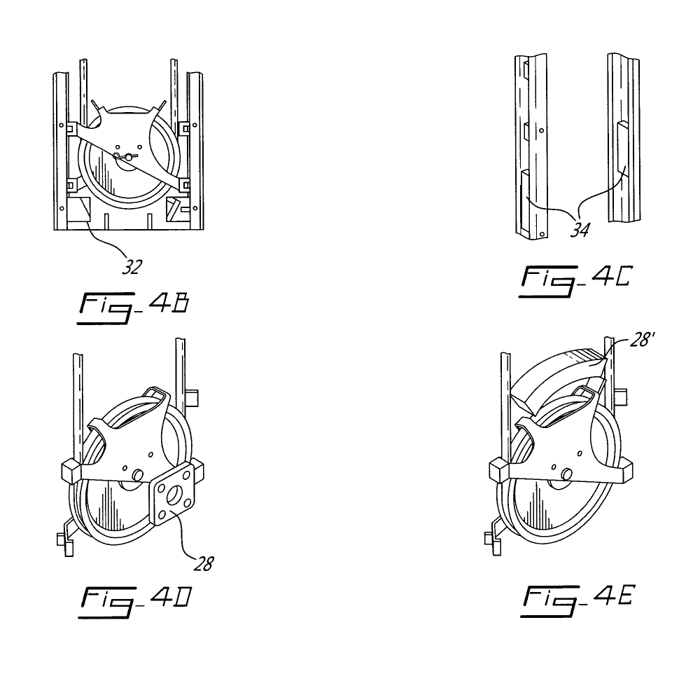

FIGS. 4a to 4e illustrate an embodiment of the cable managing system, wherein two sets of fixed and mobile pulleys 20a,24a and 20b,24b are mounted to the support structure 22 for independently managing two corresponding EV charging cables 6a, 6b at one charging site within a single cable enclosure. The first and second sets of pulleys 20a, 24a and 20b, 24b may be mounted in a back-to-back spatial relationship. Each set of pulleys operate has described above with respect to FIGS. 3a and 3b.

FIG. 4b illustrates an example of a remotely actuable electronic lock 32 for selectively locking an associated one of the mobile pulleys 24a, 24b in its lowered position, thereby preventing the associated one of the cables 6a, 6b from being pulled out of the enclosure 2a. The lock 32 may be operatively connected to the control unit of the EV charging system so that when a valid access code is entered in the system, a control commend is fed to the lock 32 to release the mobile pulley 24a. 24b, thereby allowing the user to manually draw a length of cable 6a, 6b out of the enclosure 2a. To extend the cable 6a, 6b, the user must pull on the free end of the cable with sufficient force to overcome the gravitational force acting on the mobile pulley 24a, 24b. This ensures that the cable 6a, 6b remains in tension while being used.

As shown in FIG. 4c, the lock could also take the form of an electromagnetic lock 34 integrated to counterweight 28 mounted to the mobile pulley 24a, 24b. FIGS. 4d and 4e respectively illustrate examples of laterally mounted and top mounted counterweights 28, 28′.

Referring back to FIG. 1, it can be seen that a vertically elongated recess or slot 36 may be defined in opposed sides of each upstanding enclosure 2a for accommodating an outwardly exposed length of the EV charging cables 6 when a given EV charging station 2 is not used and the associated mobile pulley 24 is in its lowered position. The elongated recess 36 may be provided with a magnetized surface for holding the exposed length of cable 6 inside the vertically elongated recess. This may be used to prevent unauthorized access to the charging cable 6. The surface would be demagnetized only upon entry of a valid access code in the system. In this way, the exposed length of the cable 6 is protected against thieves.

It is noted that since the cable management system has a slender profile, it could advantageously be integrated in an existing road side structures, such as a lamp post, thereby providing for the integration of multiple services into a single street furniture.

While according to one aspect, the power equipment and the control unit are integrated to a master charger unit 1, it is understood that the control unit as well as the power equipment could be provided within each individual cable enclosures 2a directly at the charging site. Accordingly, each charging station 2 could be autonomous. The master charger unit 1 is only one possible option.

The above description is meant to be exemplary only, and one skilled in the art will recognize that changes may be made to the embodiments described without departing from the scope of the invention disclosed. Any modifications which fall within the scope of the present invention will be apparent to those skilled in the art, in light of a review of this disclosure, and such modifications are intended to fall within the appended claims.

1. A cable management system for an electric vehicle (EV) charging station, the system comprising: an upstanding enclosure having a cable opening though which an EV charging cable can be pulled for extension, the EV charging cable being provided at a free end thereof with an EV charging connector for connection with an EV charging socket of an EV, the EV charging cable being provided at an opposed fixed end thereof with an electric connector for connection with a mating connector mounted inside the enclosure, a fixed pulley mounted within the upstanding enclosure for rotation about a first axis normal to an upstanding axis of the enclosure, and a mobile pulley rotatable about a second axis parallel to the first axis and vertically translatable within a guiding structure mounted inside the upstanding enclosure for movement towards and away from the fixed pulley, the fixed pulley being mounted at a higher elevation than the mobile pulley, wherein the EV charging cable extends over the fixed pulley and the mobile pulley between its opposed free and fixed ends, wherein the mobile pulley is moveable against gravity from a lowered position to a raised position by the application of a sufficient pulling force at the free distal end of the EV charging cable, and wherein the mobile pulley returns at least partly under gravity to its lowered position upon release of the EV charging cable, thereby automatically retracting the cable inside the upstanding enclosure.

2. The cable management system defined in claim 1, wherein a counterweight is mounted to the mobile pulley.

3. The cable management system defined in claim 1, wherein the electric connector is configured to be automatically pulled out from the mating connector inside the enclosure in the event of the application of an excessive pulling force at the free end of the EV charging cable.

4. The cable management system defined in claim 1, wherein a return stroke of the mobile pulley from its raised position to its lowered position is mechanically assisted at least in an initial phase of the return stroke.

5. The cable management system defined in claim 1, wherein a partial stroke tensioner is positioned to act upon the mobile pulley only when the mobile pulley is raised above a predetermined height, the partial stroke tensioner biasing the mobile pulley towards its lowered position.

6. The cable management system defined in claim 5, wherein the partial stroke tensioner is spring loaded by an upward movement of the mobile pulley beyond the predetermined height.

7. The cable management system defined in claim 1, wherein a lock is provided for selectively locking the mobile pulley in its lowered position.

8. The cable management system defined in claim 7, wherein the lock comprises at least one of a remotely actuable electronic or electromagnetic lock.

9. The cable management system defined in claim 1, wherein a vertically elongated recess is defined in an outer surface of the upstanding enclosure for accommodating an outwardly exposed length of the EV charging cable when the EV charging station is not used and the mobile pulley is in its lowered position, the elongated recess having a magnetized surface for selectively holding the exposed length of cable inside the vertically elongated recess.

10. An electric vehicle (EV) charging station comprising an upstanding enclosure, an EV charging cable having an EV charging connector at a free end thereof for connection with an EV charging socket of an EV and an electric connector at an opposed fixed end of the EV charging cable connected to a mating electric connector provided within the upstanding enclosure, the EV charging cable being displaceable between a retracted position in which a major portion of a length of the EV charging cable is stored within the enclosure and an extended position in which a sufficient length of cable is withdrawn from the enclosure for allowing a user to connect the EV charging connector to the EV charging socket of his/her EV, the EV charging cable between its opposed free and fixed ends being looped around a fixed pulley mounted within an upper end portion of the upstanding enclosure and one mobile pulley reciprocable along an upstanding axis inside the enclosure, wherein upon a sufficient tensile force acting on the free end of the EV charging cable, the mobile pulley is translated upwardly against gravity towards the fixed pulley, thereby extending the length of the EV charging cable available on a cable free end side of the fixed pulley.

11. The EV charging station defined in claim 10, wherein a counterweight is mounted to the mobile pulley.

12. The EV charging station defined in claim 10, wherein the electric connector is configured to be automatically pulled out from the mating connector inside the enclosure in the event of the application of an excessive pulling force at the free end of the EV charging cable.

13. The EV charging station defined in claim 10, wherein a partial stroke tensioner is positioned to act upon the mobile pulley only when the mobile pulley is raised above a predetermined height, the partial stroke tensioner biasing the mobile pulley towards a lowered position.

14. The EV charging station defined in claim 13, wherein the partial stroke tensioner is spring loaded by an upward movement of the mobile pulley beyond the predetermined height.

15. The EV charging station defined in claim 10, wherein at least one of a remotely actuable electronic or electromagnetic lock is provided for selectively preventing movement of the mobile pulley.

16. The EV charging station defined in claim 10, wherein a vertically elongated recess is defined in an outer surface of the upstanding enclosure for accommodating an outwardly exposed length of the EV charging cable when the EV charging station is not used, the elongated recess having a magnetized surface for selectively holding the exposed length of cable inside the vertically elongated recess.

17. A EV charging system comprising a plurality of EV charging stations as defined in claim 10, the charging station being operatively connected to a remote master charger unit.

18. The EV charging station defined in claim 10, wherein the upstanding enclosure is integrated in an existing road side structures, such as a lamp post, thereby providing for the integration of multiple services into a single street furniture.

19. The EV charging station defined in claim 10, further comprising power equipment and a control unit provided within the upstanding enclosures 2a directly at the charging site.
